(19) United States
(12) Patent Application Publication
(10) Pub. No.: US 2017/0070062 A1
(43) Pub. Date: Mar. 9, 2017

(54) BATTERY CHARGING SYSTEM AND METHOD

(71) Applicant: Nawaz M. Qureshi, La Mirada, CA (US)

(72) Inventor: Nawaz M. Qureshi, La Mirada, CA (US)

(21) Appl. No.: 14/849,080

(22) Filed: Sep. 9, 2015

(51) Int. Cl. H02J 7/00

(52) U.S. Cl. CPC H02J 7/007; H02J 7/0052

(57) ABSTRACT

A method for charging a battery is provided. The method comprises applying charging energy to the battery, maintaining a constant current until voltage rises to a set predetermined point, monitoring the charging energy, maintaining a constant current during dendrite shorting, terminating the charging energy when the total charge time of seven (7) hours is reached, and shortening the charge time, slightly warming up the batteries for better charge acceptance in cold conditions, and breaking down the positive grid-active material sulfation interface.

### BACKGROUND OF THE INVENTION

1. Field of the Invention

This invention relates generally to a battery charging system and method and, more particularly, the invention relates to a lead acid battery charging system and method providing a charge algorithm which substantially improves the charging and cycle life of batteries.

2. Description of the Prior Art

The existing battery chargers for golf carts have several weaknesses that frequently result in lower run times and lower battery life owing to the batteries not fully charging. This results in the blame on “bad” batteries by the golf cart manufacturers. In fact, there have been several lawsuits about this problem. There are many charging algorithms programmed in the existing battery chargers, but, most of them use complex steps and do not solve the inadequate charging problem. The reason for this is that, frequently, the chargers' maximum current (Amperes) capability is lowered to cut costs without fully analyzing the short term and long term effects on inadequately charging the batteries. At lower currents, and the other charge parameters, not enough time is available to fully charge the batteries on a busy golf course. There are numerous variations of charge algorithms that the chargers in the market use.

None of the existing methodologies simultaneously take into accounts all of the important variables while charging: mainly the battery age, temperature, and possible micro-shorts, caused by dendrite growth, and so on that all batteries develop when they age, but still have plenty of useful life. In addition to the above, there is a confusing and not easily understood terminology by the battery user: Bulk Charge, Absorption Charge, Finishing Charge, Float Charge, and the Equalization Charge. Based on the customer calls, the most misunderstood term is the Float Charge. Most of the customers mistakenly understand it to mean that it is part of normal day to day charging. Instead, it is really for long term battery storage that overcomes the self discharge.

### SUMMARY

The present invention is a method for charging a battery is provided. The method comprises applying charging energy to the battery, maintaining a constant current until voltage rises to a set predetermined point, monitoring the charging energy, maintaining a constant current during dendrite shorting, terminating the charging energy when the total charge time of seven (7) hours is reached, and shortening the charge time, slightly warming up the batteries for better charge acceptance in cold conditions, and breaking down the positive grid-active material sulfation interface. Dendrite growth is a pathological condition that normally results in premature death of batteries.

The present invention further includes a battery charging device for charging a battery. The battery charging device comprises a charging energy applied to the battery and a constant current maintained until voltage rises to a set predetermined point. The constant current is maintained even if there is dendrite shorting (a common pathological condition) for aged batteries, and terminating the charging energy when the total charge time of seven (7) hours is reached and wherein the charge time is shortened, slightly warming up the batteries for better charge acceptance in cold conditions, and breaking down the positive grid-active material sulfation interface. The time limit prevents damage to the battery or battery pack associated with over-charging while allowing a complete charge.

### BRIEF DESCRIPTION OF THE DRAWINGS

FIG. 1 is a graph illustrating a C7 charge curve, (after a full 56 Amps discharge to 10.5 Volts), 17.3 Amperes C, 10.33 Volts, for US8VE battery with eight hours total charge time;

FIG. 2 is a graph illustrating the cycling test using the charge algorithm of FIG. 1, in accordance with the present invention;

FIG. 3 is a graph illustrating a charge curve with the charge algorithm in accordance with the present invention, with the current being (155÷7) 22.1 Amperes, the voltage being 15.25 Volts, and 7 hours total charge time;

FIG. 4 is a graph illustrating the cycling test using the charge algorithm of FIG. 3, for only 51 cycles; and

FIG. 5 is a graph illustrating the temperatures for about 3 cycles during cycling in the battery of FIG. 4, with the temperatures, top curve staying within an acceptable range of 70 degrees F. to 87 degrees F.

### DETAILED DESCRIPTION OF THE PREFERRED EMBODIMENTS

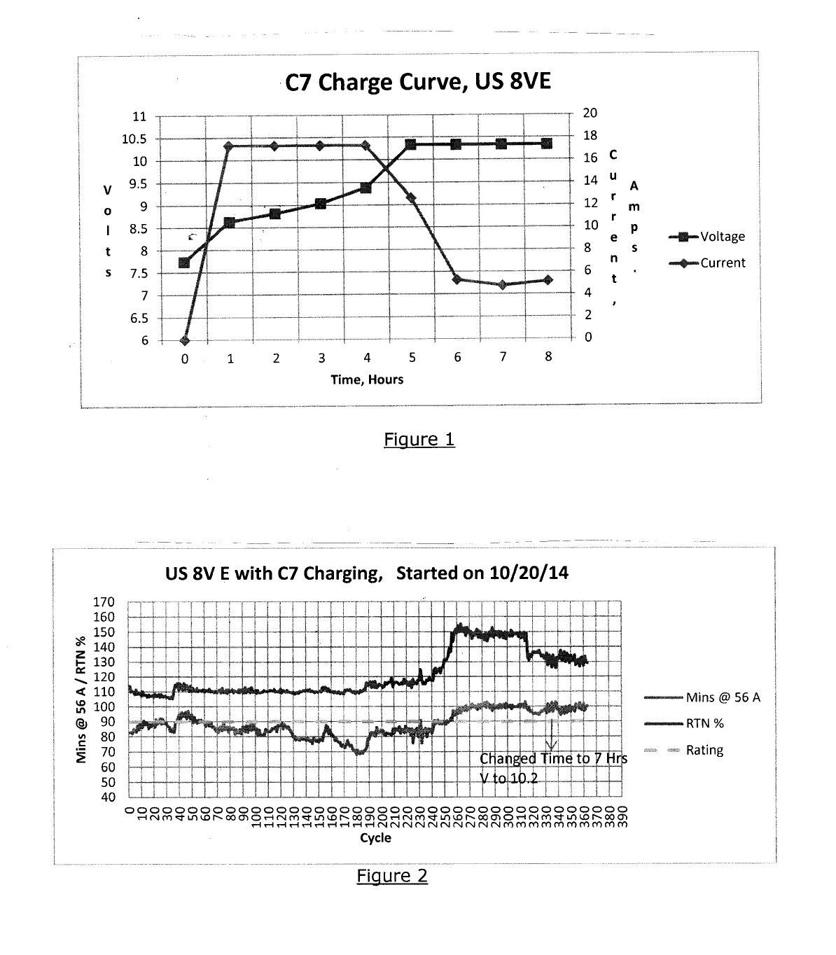

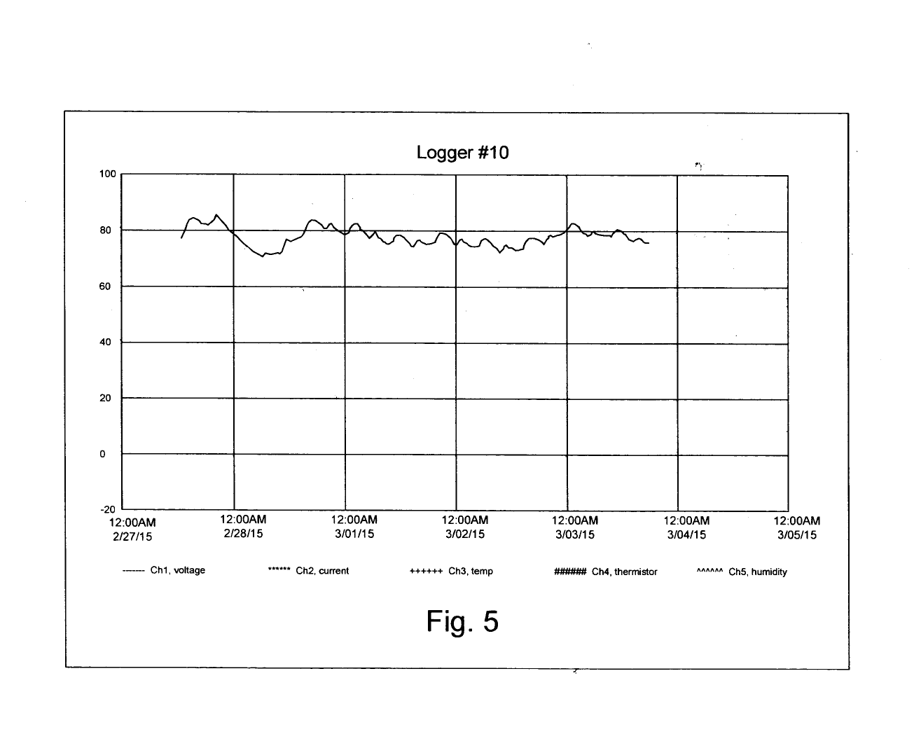

As illustrated in FIGS. 1-5, the present invention is a battery charging system and method providing a charge algorithm which substantially improves the charging to full battery capacity and cycle life of batteries. The battery charging system of the present invention is a charging methodology that eliminates most, if not all, of the battery charging problems encountered in the golf cart industry and similar applications such as in scissor lifts and marine applications, thus creating a high performance, and longer lasting battery energy storage system.

### Work Done:

The battery charging system and method of the present invention is a charging algorithm that reduces the charge time, improves the low temperature charging, acid (electrolyte) mixing and minimizes and possible damage to the batteries during the charge cycle. The algorithm of the present invention works very well with deep cycle batteries.

The algorithm's parameters constants are somewhat flexible for further improvements if necessary. The constants are described in the Table 1 below:

This algorithm is called “C7”. With the C7 algorithm, all charger parameters' limits are fixed:

TABLE 1

| Parameter | Latest Version | Preceding Version* |
|---|---|---|
| Total Charge Time | 7 Hours | 8 Hours |
| Maximum Current | C20h ÷ 7 | C20h ÷ 7 |
| Maximum Voltage | 2.541 Volts per cell | 2.583 Volts per cell |

*Also invented by the present inventor as a trial.

Initially there is constant current until the voltage rises to the set point when the current starts to drop. The amount of the current drop will be a function of the normal current acceptance variables at a constant voltage, namely the temperature, acid SG (Specific Gravity depicting concentration), the depth of the preceding discharge and possible micro or macro shorts. In case of severe dendrite internal shorting, the current may not drop. However, the charge will terminate when the total charge time of 7 hours runs out, preventing any overcharge and undesirable thermal runaway condition. The higher current will shorten the charge time, warm up the batteries slightly for better charge acceptance in cold conditions, and tend to break down the undesirable positive grid-active material sulfation interface.

FIG. 1 illustrates a typical C7 charge curve, after a full 56 Amps discharge, 17.3 Amperes C, 10.33 Volts, for US8VE battery with 8 hours total charge time. FIG. 2 illustrates the total charge time and the voltage setting when changed to the latest version of the algorithm seven (7) hours charge time and 10.20 Max Voltage at cycle 332.

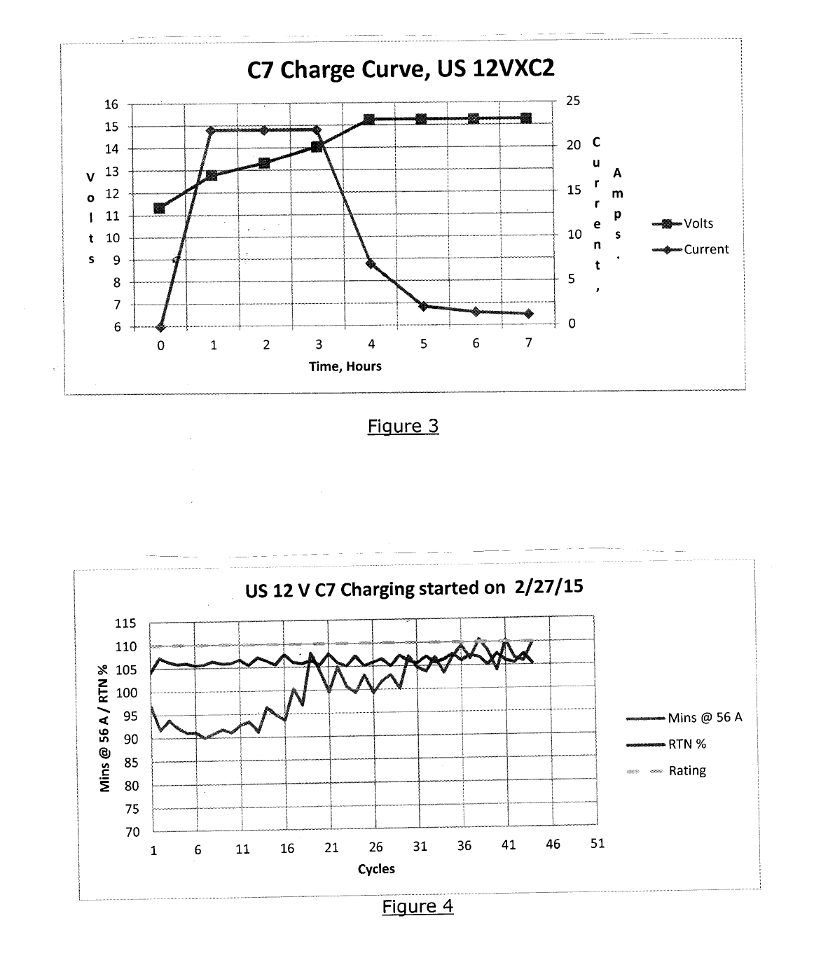

FIG. 3 illustrates a typical charge curve with the latest charge algorithm. The current is (155÷7) 22.1 Amperes, the voltage 15.25 and 7 hours total charge time. FIG. 4 illustrates the algorithm for only 51 cycles.

In sum, C7 provides a good full charge for golf cart and similar applications. The charging algorithm is very simple making the charger design also very simple and low cost. The charger/algorithm of the present invention can solve most of the charger related problems being encountered in the field.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A method for charging a battery comprising:
applying charging energy to the battery;
maintaining a constant current until voltage rises to a set predetermined point;
monitoring the charging energy;
dropping the current at the set predetermined point;
wherein the amount of the current drop is a function of the normal current acceptance variables at a constant voltage.

2. The method of claim 1 wherein the normal current acceptance variable is temperature.

3. The method of claim 1 wherein the normal current acceptance variable is acid SG (concentration).

4. The method of claim 1 wherein the normal current acceptance variable is the depth of the preceding discharge.

5. The method of claim 1 wherein the normal current acceptance variable is micro or macro shorts aging under use.

6. The method of claim 1 and further comprising:
maintaining a constant current during dendrite shorting.

7. The method of claim 6 and further comprising:
terminating the charging energy when the total charge time of seven (7) hours is reached.

8. The method of claim 7 and further comprising:
shortening the charge time, slightly warming up the batteries for better charge acceptance in cold conditions, and breaking down the positive grid-active material sulfation interface.

9. A method for charging a battery comprising:
applying charging energy to the battery;
maintaining a constant current until voltage rises to a set predetermined point;
monitoring the charging energy;
maintaining a constant current during dendrite shorting;
terminating the charging energy when the total charge time of seven (7) hours is reached; and
shortening the charge time, slightly warming up the batteries for better charge acceptance in cold conditions, and breaking down the positive grid-active material sulfation interface.

10. A battery charging device for charging a battery, the battery charging device comprising:
a charging energy applied to the battery;
a constant current maintained until voltage rises to a set predetermined point;
wherein the charging energy is terminated when the total charge time of seven (7) hours is reached; and
wherein the charge time is shortened, slightly warming up the batteries for better charge acceptance in cold conditions, and breaking down the positive grid-active material sulfation interface.

11. The battery charging device of claim 10 wherein the constant current is maintained during dendrite shorting.
